(19) United States
(12) Patent Application Publication
(10) Pub. No.: US 2009/0091809 A1
(43) Pub. Date: Apr. 9, 2009

(54) Image Processing Device, Method and Program Product

(75) Inventors: Takashi HYUGA, Suwa-shi (JP); Kimitake MIZOBE, Shiojiri-shi (JP); Nobuhiro KARITO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/244,652

(22) Filed: Oct. 2, 2008

(30) Foreign Application Priority Data
Oct. 4, 2007 (JP) 2007-260992

(51) Int. Cl. H04N 1/46

(52) U.S. Cl. 358/505

(57) ABSTRACT

First integrated data is generated using tone value data. The tone value data represents respective tone values of pixels of an image. The first integrated data represents respective first pixel values of the pixels. The first pixel value is associated with sum of tone values of pixels within a rectangle in the image. The rectangle has two opposing corners represented by a pixel corresponding to the first pixel value and a reference pixel respectively. The reference pixel is a pixel at a predetermined corner of the image. A calculation process is executed. The calculation process includes calculation of a first calculation value of a target rectangle area using the first integrated data. The first calculation value is correlated to sum of tone values within the target rectangle area. The target rectangle area is enclosed by a rectangle defined by pixel boundary lines. The pixel boundary lines represent boundary lines between neighboring pixels in the image. Image processing in relation to the target rectangle area is executed in accordance with the result of the calculation process. In the calculation of the first calculation value, the first calculation value is calculated using respective first pixel values of four calculation pixels. The four calculation pixels are respectively adjacent to four vertexes of the target rectangle area in the direction of the reference pixel. The four vertexes are on the pixel boundary lines.

### CROSS-REFERENCE TO RELATED APPLICATIONS

The present application claims the priority based on Japanese Patent Application No. 2007-260992 filed on Oct. 4, 2007, the disclosure of which is hereby incorporated by reference in its entirety.

### BACKGROUND

1. Technical Field

The present invention relates to a device, a method, and a program product for image processing.

2. Description of the Related Art

Various image processing technologies are known. For example, those technologies are known which include performing image correction processes on image data that has been read by a copier, image scanner, fax machine or the like, with a view to outputting a higher picture quality image. In relation to such technologies, those technologies are known which include determining attributes (e.g. characters or halftone dots) of images.

### SUMMARY

However, image data that represents an image will contain a large number of pixels, in most instances such image attribute determination processes entailed a high processing load. This kind of problem is not limited to determination of image attributes, but is a problem common to processing of tone value data representing tone values of individual pixels of images made up of multiple pixels arranged in a matrix pattern.

An advantage of some aspects of the invention is to provide a technology whereby the processing load associated with processing of tone value data can be reduced.

In an first aspect of the invention, an image processing device is provided. The image processing device processes an image including a plurality of pixels. The image processing device includes an integrated data generator, a calculator and an image processor. The integrated data generator generates first integrated data using tone value data. The tone value data represents respective tone values of pixels of an image. The first integrated data represents respective first pixel values of the pixels. The first pixel value is associated with sum of tone values of pixels within a rectangle (including a square) in the image. The rectangle has two opposing corners represented by a pixel corresponding to the first pixel value and a reference pixel respectively. The reference pixel is a pixel at a predetermined corner of the image. The calculator executes a calculation process including calculation of a first calculation value of a target rectangle area using the first integrated data. The first calculation value is correlated to sum of tone values within the target rectangle area. The target rectangle area is enclosed by a rectangle (including a square) defined by pixel boundary lines. The pixel boundary lines represent boundary lines between neighboring pixels in the image. The image processor executes image processing in relation to the target rectangle area in accordance with the result of the calculation process. In the calculation of the first calculation value, the first calculation value is calculated using respective first pixel values of four calculation pixels. The four calculation pixels are respectively adjacent to four vertexes of the target rectangle area in the direction of the reference pixel. The four vertexes are on the pixel boundary lines.

With this arrangement, the respective first pixel values of four calculation pixels in the first integrated data are utilized to calculate a first calculation value having correlation with sum of tone values within the target rectangle area, thereby reducing the processing load associated with processing of tone value data.

Note that the invention may be embodied in various other modes, for example, an image processing method and device; a computer program to implement the functions of such a method or device; or a recording medium having such a computer program recorded thereon.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a Illustration depicting the schematic configuration of a printer 10.

FIG. 2 is a flowchart depicting the flow of an image reproduction process.

FIG. 3 is a flowchart depicting the flow of an area classification process.

FIG. 4 is a schematic illustration of target image data SI and a pixel of interest.

FIG. 5 is a schematic illustration of the target image data SI and first integrated data ID1.

FIG. 6 is a schematic illustration of calculation of the average using the first integrated data ID1.

FIG. 7 is a flowchart depicting the flow of an area determination process (attribute determination process).

FIG. 8 is a Illustration depicting an example of luminance values in partial areas.

FIGS. 9A-9C are Illustrations depicting exemplary histograms of variance.

FIG. 10 is a Illustration depicting an example of a partial area representing a halftone part.

FIG. 11 is a flowchart depicting another embodiment of an area determination process (attribute determination process).

FIG. 12 is a Illustration depicting an example of luminance values in three partial areas.

FIGS. 13A-13C are Illustrations depicting exemplary histograms of variance.

FIG. 14 is a schematic illustration depicting results of determination of image areas IP representing characters and halftones.

### DESCRIPTION OF THE PREFERRED EMBODIMENT

### A. Embodiment 1

A preferred embodiment for carrying out the invention will be described below.

### A-1 Schematic Configuration of Printer 10

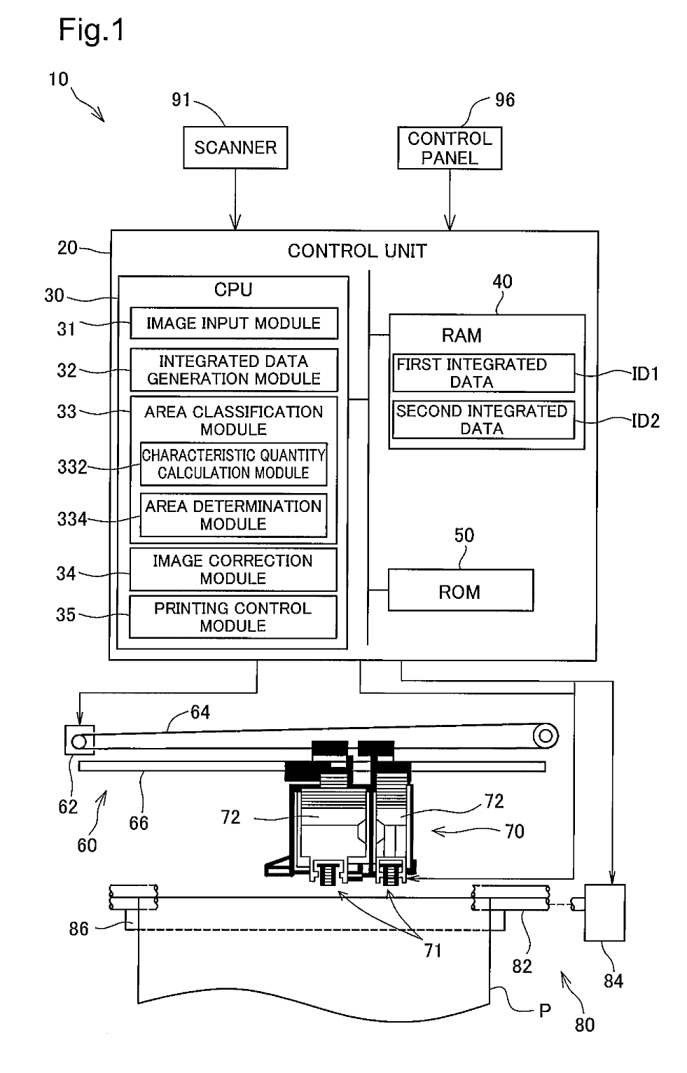

FIG. 1 is an illustration depicting the schematic configuration of printer 10 according to an embodiment of the image processing device herein. The printer 10 is a so-called multifunction device (complex machine) having a scanner function and a copier function, in addition to a printer function. The printer 10 includes a control unit 20, a carriage transport mechanism 60, a carriage 70, a paper feed mechanism 80, a scanner 91, and a control panel 96.

The carriage transport mechanism 60 includes a carriage motor 62, a drive belt 64, and a slide rail 66. The carriage transport mechanism 60 drives the carriage 70 moveably retained on the slide rail 66 in the main scan direction. The carriage 70 includes an ink head 71 and an ink cartridge 72. The ink head 71 ejects the ink supplied to the ink head 71 from the ink cartridge 72 onto printer paper P. The paper feed mechanism 80 includes a paper feed roller 82, a paper feed motor 84, and a platen 86. The paper feed motor 84 rotates the paper feed roller 82 to carry the printer paper P along the upper face of the platen 86. The scanner 91 is an image scanner that optically reads images. In this embodiment, the CCD (Charge Coupled Device) is used, but various other image scanners, such as the CIS (Contact Image Sensor) could be used as well.

The mechanisms mentioned above are controlled by the control unit 20. The control unit 20 is configured as a microcomputer that includes a CPU 30, a RAM 40, and a ROM 50. By loading into the RAM 40 a program stored in the ROM 50 and then executing the program, the control unit 20 controls the mechanisms mentioned above and carries out the functions of the function modules depicted in FIG. 1. These function modules will be discussed in detail later.

The printer 10 having the configuration described above also functions as a copier, by printing out images scanned with the scanner 91 onto printer paper P. The printing mechanism is not limited to the ink-jet printing discussed above, and various other types of printing such as the laser printing or thermal transfer printing can be used.

### A-2. Image Reproduction Process:

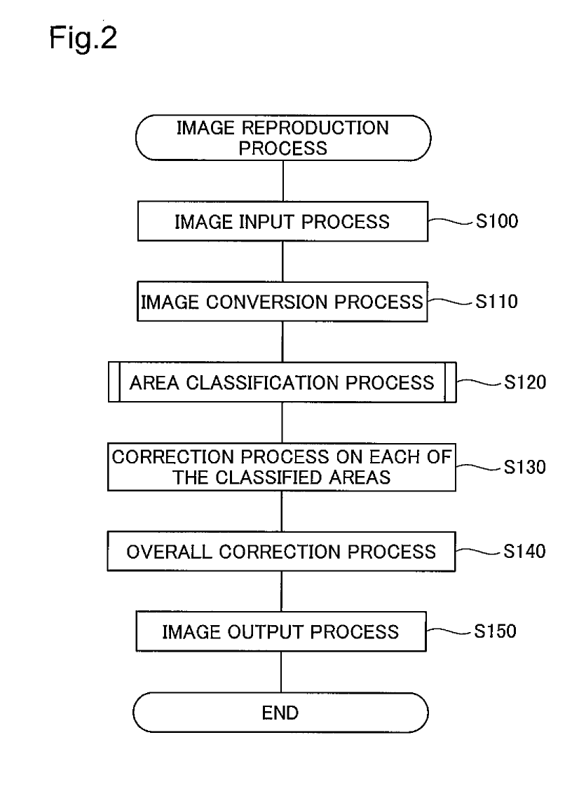

FIG. 2 shows a flowchart of the flow of an image reproduction process for carrying out copying of a given image using the printer 10. This process is initiated when the user places an image targeted for copying (e.g. printed matter or other original document) on the printer 10, and performs a Copy instruction operation from the control panel 96. When the process starts, the CPU 30, as an image input process, uses the scanner 91 to convert the imaged optical image to electrical signal form (Step S100). Then, as an image conversion process, the resultant analog signal is converted into a digital signal by an AD conversion circuit (not shown), and shading correction is carried out by the CPU 30 to give the image uniform brightness throughout (Step S110).

The resultant image data (also termed “target image data”) is subjected to area classification for each of the plural pixels (Step S120). This process is a process for classifying the pixels that make up an image, as either pixels that make up edge parts or pixels that make up halftone parts. The details will be described later in “A-3. Area Classification Process.”

Next, the CPU 30 performs an appropriate correction process on each of the classified areas (Step S130), as a process of the image correction module 34. This process is a process carried out, for example, through spatial filtering using an enhancer filter for pixels classed as edge constituent areas and a smoothing filter for pixels classed as halftone constituent areas. By carrying out the correction process, the edge constituent areas can be made sharper and moiré can be suppressed in halftone constituent areas, in the image output process of Step S150 to be discussed later.

After the correction process on each of the classified areas, the CPU 30 carries out an overall correction process that may include gamma correction, color correction to minimize color information errors between input image and output image, etc., so as to accurately reproduce coloring during output (Step S140). Next, the CPU 30 drives the carriage transport mechanism 60, the carriage 70, and paper feed mechanism 80 and so on to output the image onto the printer paper P (Step S150), as a process of the printing control module 35. In this way, the image reproduction process completes.

### A-3. Area Classification Process:

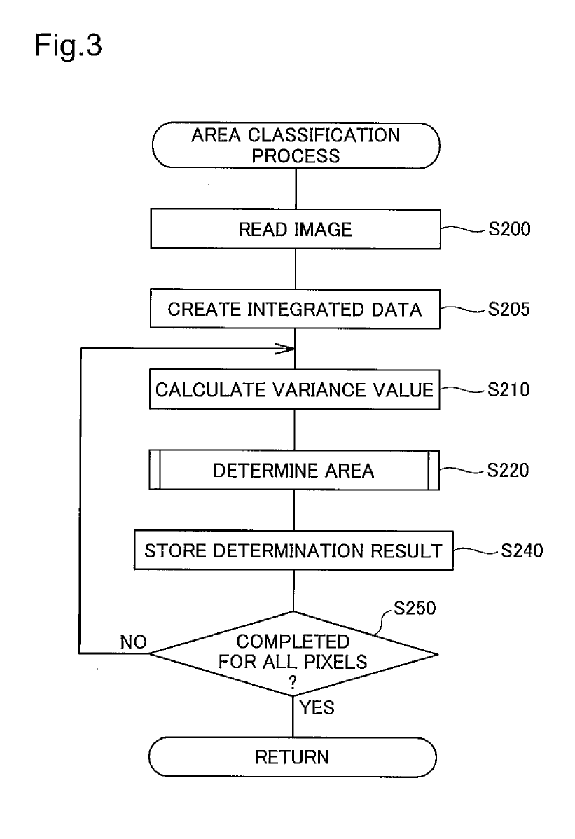

FIG. 3 shows a flowchart depicting the flow of the area classification process shown in Step S120 of FIG. 2. When this process starts, in the Step S200, the CPU 30 loads into the RAM 40 the image data (in this embodiment, RGB data) that has been acquired in aforementioned Step S110, as a process of the image input module 31.

In the next Step S205, the CPU 30 analyzes the target image data to generate first integrated data ID1 (FIG. 1) and second integrated data ID2 (FIG. 1), as a process of the integrated data generation module 32. Where reading of the image data is carried out individually for bands, the integrated data ID1, ID2 may be generated individually for bands as well. The CPU 30 then stores the integrated data ID1, ID2 into the RAM 40. The integrated data ID1, ID2 is discussed in detail later in “A-4. Calculations Using Integrated Data.”

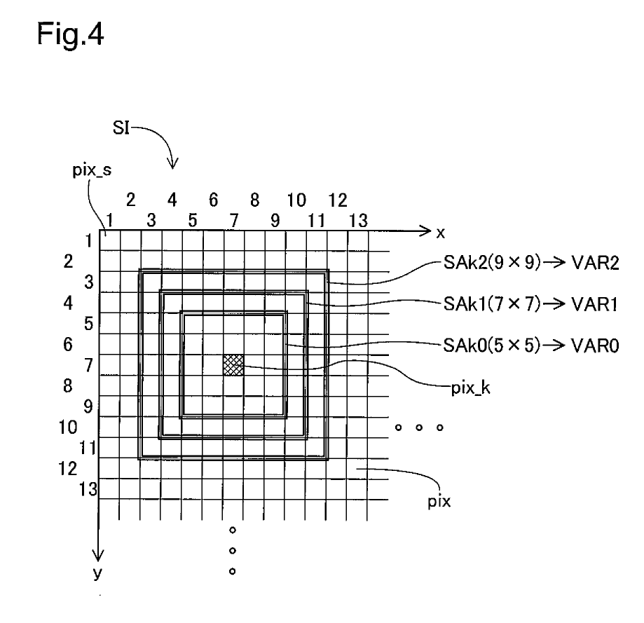

In the next Step S210, the CPU 30 calculates the statistical variance (hereinafter termed simply “variance”) of luminance values in a partial area containing a pixel of interest, as a process of the characteristic quantity calculation module 332 (included in the area classification module 32). FIG. 4 is a schematic illustration depicting target image data SI and a pixel of interest pix_k. The target image data SI represents respective tone values of a plurality of pixels pix arranged in a matrix pattern in the horizontal direction (x direction) and the vertical direction (y direction). Hereinafter, with reference to the pixel located at the apical point (corner) at upper left (hereinafter, this pixel is termed the “reference pixel pix_s”), the other pixels are supposed to line up in the +x and the +y direction, respectively.

In FIG. 4, the pixel of interest pix_k is shown. The pixel of interest pix_k is a pixel targeted for attribute determination, for the purpose of determining whether the pixel belongs to an edge part or to a halftone part. In this embodiment, the CPU 30 shifts the pixel of interest in order from the pixel at the upper left corner to the pixel at the lower right corner of the image to determine attributes of individual pixels.

As will be discussed later, the attribute of the pixel of interest pix_k is determined according to respective variances of luminance values of three partial areas SAk0, SAk1, SAk2 each including the pixel of interest pix_k. Each of the partial areas SAk0 -SAk2 is a square area centered on the pixel of interest pix_k (the first partial area SAk0 corresponds to 5×5 pixels, the second partial area SAk1 corresponds to 7×7 pixels, and the third partial area SAk2 corresponds to 9×9 pixels).

The CPU 30 calculates variance for each of the partial areas SAk0, SAk1, SAk2 In accordance with the following Equation 1.

V(f)=E(f²)−(E(f))² [Eq. 1]

f: luminance value

V: variance

E: average value

As will be discussed later, the CPU 30 calculates the average value E(f) of the luminance values f according to the first integrated data ID1 (FIG. 1), and calculates the average value E(f²) of the luminance values f in the square according to the second integrated data ID2. The calculated variance is used in the next Step S220.

Next, the CPU 30 carries out an area determination process (also termed an attribute determination process) as a process of the area determination module 334 (also termed the attribute determination module 334) of the area classification module 33. The CPU 30 determines whether the pixel of interest represents an edge constituent area or a halftone constituent area (Step S220). The details of this attribute determination process will be described later in “A-5. Attribute Determination Process.”

After the determination of the attribute of the pixel of interest, the CPU 30 stores (writes) the result into the RAM 40 (Step S240). Then, the CPU 30 determines whether the above processing has been completed for all pixels of the target image represented by the target image data (Step S250). If not completed (Step S250: NO), the CPU 30 returns the process to Step S210. If completed (Step S250: YES), the CPU 30 terminate the area classification process to return to the image reproduction process of FIG. 2.

### A-4. Calculations Using Integrated Data:

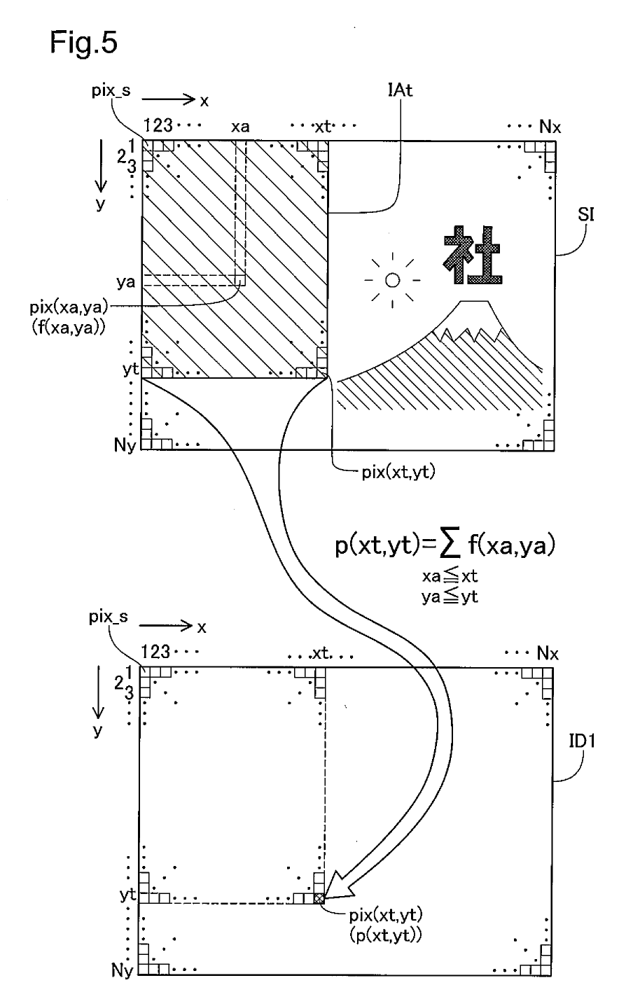

FIG. 5 is a schematic illustration of the target image data SI and the first integrated data ID1. Hereinafter, a pixel located at the xa-th location in the x direction and at the ya-th location in the y direction from the reference pixel pix_s is denoted as pix(xa, ya). The luminance value of that pixel is denoted as f(xa, ya). The range of xa is from 1 to Nx, and the range of ya is from 1 to Ny (Nx and Ny are integers, and determined based on the target image data SI). Luminance values of pixels can be derived using known methods, from the RGB tone values represented by the pixels.

The first integrated data ID1 represents the integrated luminance value (the sum value of the luminance values) at each of the pixels of the target image data SI (the integrated luminance value for each pixel corresponds to the “first pixel value” in the Claims). The integrated luminance value p(xt, yt) of a given pixel pix(xt, yt) is represented by Equation 2 below.

$$p ( xt , yt ) = {\sum }_{xa \leq xt , ya \leq yt} f ( xa , ya ) \qquad [ Eq . 2 ]$$

This integrated luminance value p(xt, yt) represents the sum value of luminance values of pixels within a rectangle (including a square) area IAt (in FIG. 5, the rectangle area IAt is shown with hatching). The two opposing (diagonally located) corners of the rectangle area IAt are represented by two pixels of the reference pixel pix-s and the pixel pix(xt, yt) respectively.

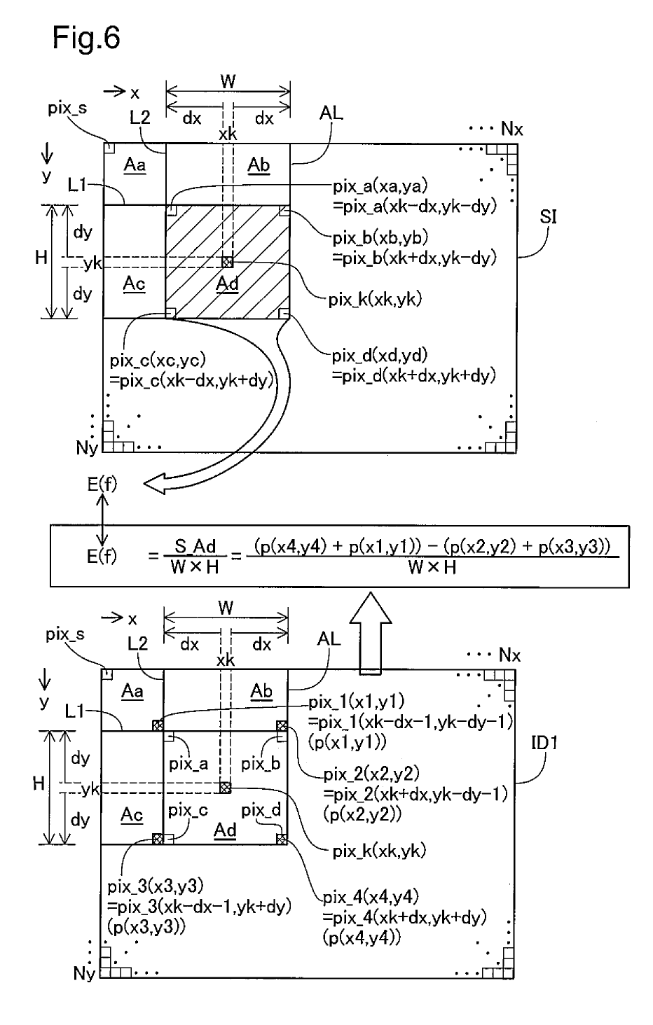

FIG. 6 is a schematic illustration of calculation of the average using the first integrated data ID1. FIG. 6 depicts the same target image data SI and integrated data ID1 as in FIG. 5. A target rectangle area Ad centered on the pixel of interest pix_k (=pix(xk, yk)) is depicted in the image data SI, ID1. The number of pixels W in the x direction of this target rectangle area Ad is “2×dx+1”. The number of pixels H in the y direction of this target rectangle area Ad is “2×dy+1”. The number dx is an integer equal to or greater than 1, and the number dy is an integer equal to or greater than 1.

The four corner pixels pix_a to pix_d of the target rectangle area Ad are depicted in the drawing. The first corner pixel pix_a is the corner pixel located closest to the reference pixel pix_s. The fourth corner pixel pix_d is the corner pixel located furthest away from the reference pixel pix_s. The second corner pixel pix_b is another corner pixel included in the same pixel row as the first corner pixel pix_a, and the third corner pixel pix_c is another corner pixel included in the same pixel column as the first corner pixel pix_a.

A corner rectangle area AL is depicted in FIG. 6. This corner rectangle area AL is a rectangle area whose two opposing corners are represented by two pixels of the reference pixel pix_s and the fourth corner pixel pix_d. This corner rectangle area AL is divided into four areas Aa, Ab, Ac, and Ad by two lines L1, L2 intersecting at a right angle. The first line L1 is a straight line that is parallel to the x direction and passes through the −y side of the target rectangle area Ad. The −y side represents the pixel boundary line. The pixel boundary line represents the boundary line between neighboring pixels. The second line L2 is straight line that is parallel to the y direction and passes through the −x side of the target rectangle area Ad. The −x side represents the pixel boundary line. The first area Aa is a rectangle area that includes the reference pixel pix_s, and that is located to upper left in the diagonal direction (i.e. to the −x and −y side) from the target rectangle area Ad. The second area Ab is a rectangle area that is located to the −y side of the target rectangle area Ad. The third area Ac is a rectangle area that is located to the −x side of the target rectangle area Ad.

A comparative example of calculation of the average value E(f) is shown at the upper part of FIG. 6. The average value E(f) represents the average value of luminance values f in the target rectangle area Ad. In the comparative example, luminance values of pixels within the target rectangle area Ad are read from the target image data SI, and their sum value is calculated. The sum value is then divided by the total number of pixels (W×H) to calculate the average value E(f). In this case, in order to calculate the average value E(f) relating to a single pixel of interest pix_k, it is necessary to access the target image data SI (RAM 40) H×W times. For example, where H=9 and W=9, 81 accesses is needed. Calculation (addition) of 81 values is needed as well.

Calculation of the average value E(f) in accordance with this embodiment is depicted at the lower part of FIG. 6 (the average value E(f) corresponds to the “first calculation value” in the Claims). In the drawing, four calculation pixels pix_{—}1 to pix_{—}4 utilized to calculate the average value E(f) are shown. The CPU 30 selects these four calculation pixels pix_{—1} to pix_{—}4 in accordance with the locations of the four corner pixels pix_a to pix_d.

The first calculation pixel pix_{—}1 is the pixel at a location arrived at by shifting the row by one and the column by one towards the reference pixel pix_s from the first corner pixel pix_a (the row represents the position along the y direction, and the column represents the position along the x direction). The integrated luminance value p(x1, y1) of this first calculation pixel pix_{—}1 represents the sum value of luminance values within the first area Aa.

The second calculation pixel pix_{—}2 is the pixel at a location arrived at by shifting the row (the position along the y-direction) by one towards the reference pixel pix_s from the second corner pixel pix_b. The integrated luminance value p(x2, y2) of this second calculation pixel pix_{—}2 represents the sum value of luminance values throughout the entire the first area Aa and the second area Ab.

The third calculation pixel pix_{—}3 is the pixel at a location arrived at by shifting the column (the position along the x-direction) by one towards the reference pixel pix_s from the third corner pixel pix_c. The integrated luminance value p(x3, y3) of this third calculation pixel pix_{—}3 represents the sum value of luminance values throughout the entire the first area Aa and the third area Ac.

The fourth calculation pixel pix_{—}4 is identical to the fourth corner pixel pix_d. The integrated luminance value p(x4, y4) of this fourth calculation pixel pix_{—}4 represents the sum value of luminance values throughout the entire corner rectangle area AL.

These four calculation pixels pix_{—}1 to pix_{—}4 are respectively adjacent in the direction of the reference pixel pix_s to four vertexes (apical points) on the contour line of the target rectangle area Ad. The contour line of the target rectangle area Ad represents the pixel boundary lines of rectangle shape that enclose the target rectangle area Ad. Using these calculation pixels pix_{—}1 to pix_{—}4, the CPU 30 calculates the average value E(f) according to Equation 3 below.

$$\begin{matrix} E ( f ) = \frac{S\_Ad}{W \times H} \\ = \frac{( p ( x 4 , y 4 ) + p ( x 1 , y 1 ) ) - ( p ( x 2 , y 2 ) + p ( x 3 , y 3 ) )}{W \times H}\end{matrix} \\ ( S\_Ad: sum value of luminance values f within area Ad ) \qquad [ Eq . 3 ]$$

In this embodiment, irrespective of the magnitude of H and W, the average value E(f) relating to a single pixel of interest pix_k can be calculated through access four times to the first integrated data ID1 (RAM 40). Thus, in the embodiment, the number of times of access to the RAM 40 can be reduced appreciably, as compared with the comparative example. Moreover, since the numerator can be calculated by an operation (addition and subtraction) of the four values, the load entailed in the operation can be reduced appreciably. Furthermore, the CPU 30 can calculate an average value E(f) within an arbitrary rectangle area in the same way using the first integrated data ID1.

Calculation of the average value E(f²) of the squares (f²) of luminance values f is analogous to calculation of the average value E(f) of the luminance values f (the average value E(f²) corresponds to the “second calculation value” in the Claims). The second integrated data ID2 (FIG. 1) that has been generated in Step S205 of FIG. 3 represents the integrated value of squared luminance values (the sum of squared luminance values) at each of the pixels of the target image data SI (the integrated value for each pixel corresponds to the “second pixel value” in the Claims). The squared luminance integrated value ps(xt, yt) of a given pixel pix(xt, yt) is represented by Equation 4 below.

$$p s ( xt , yt ) = {\sum }_{xa \leq xt , ya \leq yt} {( f ( xa , ya ) )}^{2} \qquad [ Eq . 4 ]$$

In Step S210 of FIG. 3, the CPU 30 acquires the squared luminance integrated values ps of the aforementioned four calculation pixels pix_{—}1 to pix_{—}4 from the second integrated data ID2 (RAM 40). Then, the CPU 30 calculates the average value E(f²) of the squares of the luminance values f according to Equation 5 below.

$$E ( {f}^{2} ) = \frac{\begin{matrix}( p s ( x 4 , y 4 ) + p s ( x 1 , y 1 ) ) - \\ ( p s ( x 2 , y 2 ) + p s ( x 3 , y 3 ) )\end{matrix}}{W \times H} \qquad [ Eq . 5 ]$$

In Step S210 of FIG. 3, the CPU 30 calculates the variance V(f) using the calculated average value E(f), E(f²) (Equation 1). In the calculation of variance VAR0 of the first partial area SAk0 (FIG. 4), dx=dy=2 (FIG. 6). In the calculation of variance VAR1 of the second partial area SAk1, dx=dy=3. In the calculation of variance VAR2 of the third partial area SAk2, dx=dy=4.

### A-5. Attribute Determination Process

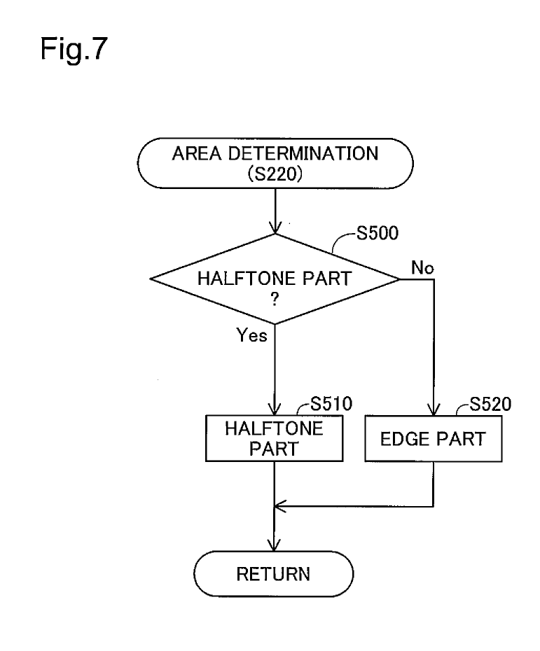

FIG. 7 is a flowchart depicting the flow of the area determination process (attribute determination process) shown in Step S220 of FIG. 3. The CPU 30 executes the process of Steps S500 to S520 depicted in FIG. 7, as a process of the area determination module 334 that is included in the area classification module 33. This attribute determination process is also a type of image processing. The area determination module 334 corresponds to the “image processor” recited in the claims.

In the initial Step S500, the CPU 30 uses the variance of luminance values to determine whether a pixel of interest represents a halftone part.

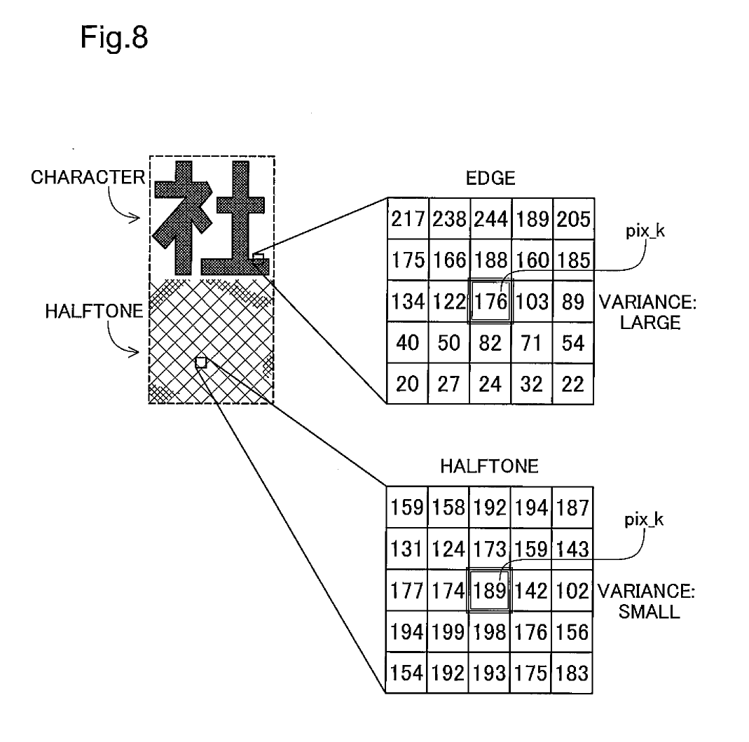

FIG. 8 depicts an example of luminance values in two partial areas, namely, an edge part and a halftone part. If a pixel of interest pix_k represents an edge part, the color will change in the partial area appreciably, and thus typically the luminance value variance will be large. If a pixel of interest pix_k represents a halftone part, color will change in a periodic manner in the partial area. Since in most instances change in color in halftone parts is smaller than in edge parts, the luminance value variance will be smaller in halftone parts than in edge parts.

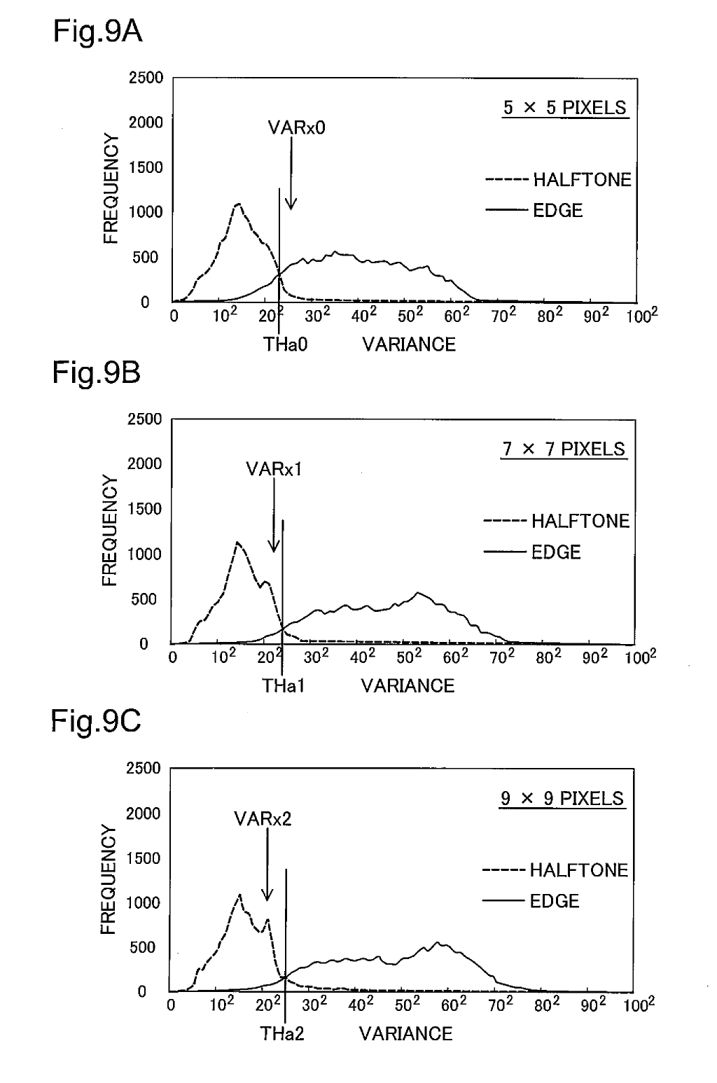

FIGS. 9A, 9B, and 9C depict exemplary histograms of variance in partial areas of 5×5 pixels, 7×7 pixels, and 9×9 pixels, respectively (the horizontal axes have been set up so that the standard deviation (the positive square root of the variance) line up uniformly). Each histogram depicts the respective variances of a halftone part and of an edge part. These histograms have been created according the results of analysis of various areas of various sets of image data. As illustrated, the bias in variance distribution will differ between the halftone part and the edge part. Thus, by comparing magnitude of variance with a threshold value, it can be determined with a certain level of accuracy whether a pixel of interest represents an edge part or a halftone part.

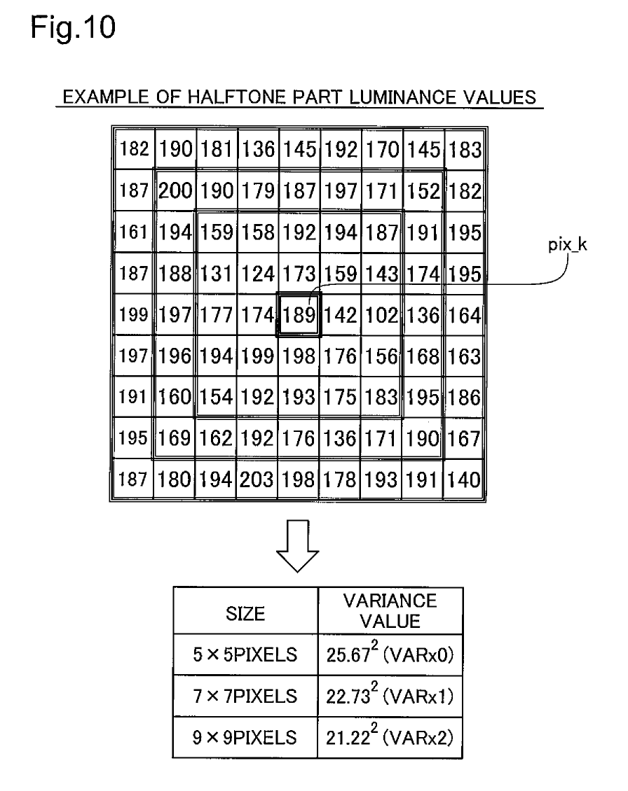

Further, the accuracy of determination can be improved by putting together the variance of a plurality of partial areas. FIG. 10 depicts an example of a partial area representing a halftone part. The drawing shows variances VARx0-VARx2 for 5×5 pixels, for 7×7 pixels, and for 9×9 pixels, respectively. The variances VARx0-VARx2 shown in the histograms in FIG. 9 indicate the variances shown in FIG. 10.

As depicted in FIG. 9, the variance VARx0 for 5×5 pixels exhibits a particularly large value (a relatively low frequency value) in the typical variance distribution of a halftone part. When this variance VARx0 is utilized exclusively, there is a high probability that a pixel of interest pix_k will be misidentified as an edge part. On the other hand, the variance VARx1 for7×7 pixels and the variance VARx2 for 9×9 pixels exhibit close-to-peak values (relatively high frequency values) in the typical variance distribution. Accordingly, the probability of misidentification (erroneous determination) can be reduced by further utilizing these variances VARx1, VARx2.

The respective variances of a plurality of partial areas will vary according to a color change pattern (e.g. subject size or halftone size represented by the target image) around the pixel of interest pix_k. As a result, the partial area most appropriate for determination from among a plurality of partial areas may vary according to the color change pattern. For example, the use of variance of 5×5 pixels may in some instances reduce the probability of misidentification, as compared with variance of 9×9 pixels.

Accordingly, in this embodiment, in order to improve the accuracy of determination irrespective of such color change patterns, the CPU 30 makes such determinations utilizing the respective variances VAR0, VAR1, VAR2 of the three partial areas SAk0, SAk1, SAk2 (FIG. 4) of different size. Specifically, in the event that an evaluation value EVa calculated according to Equation 6 below is 0 or greater than 0, the CPU 30 determines that the pixel of interest pix_k represents an edge part. In the event that the evaluation value EVa is less than 0, the CPU 30 determines that the pixel of interest pix_k represents a halftone part.

$$EVa = {\sum }_{t = 0}^{T} {Ca}_{t} sign [ {VAR}_{t} - {THa}_{t} ] \\ ( \begin{matrix}EVa \geq 0 \text{:} edge part \\ EVa < 0 \text{:} halftone part\end{matrix} ) \qquad [ Eq . 6 ]$$

The identifier t is a partial area identifier. In this embodiment, t=0 corresponds to 5×5 pixels, t=1 corresponds to 7×7 pixels, and t=2 corresponds to 9×9 pixels. The maximum value T is the maximum value of the identifier t (in this embodiment, T=2). The coefficients Cat (t=0,1,2) are predetermined positive values that represent weighting coefficients for partial areas respectively. The threshold values THat (t=0,1,2) are predetermined threshold values of variances for partial areas respectively. The variances VARt (t=0,1,2) are the variances of partial areas respectively. The sign function sign is a function that returns the sign of the argument. Where VARt>THat, sign=+1; where VARt=THat, sign=0; and where VARt<THat, sign=−1.

The evaluation value EVa represents a weighted summation value of determination results indicating whether VARt is greater than THat (each determination result is weighted for each partial area respectively). Consequently, where, as in the example depicted in FIG. 10, correct determination results cannot be obtained from a certain partial area, correct determination results may nevertheless be obtained by further utilizing a different partial area. As a result, determination accuracy can be increased irrespective of color change patterns. The threshold values THa0, THa1, THa2 and the coefficients Ca0, Ca1, Ca2 may be determined experimentally and empirically in advance through analysis of a large number of images.

The CPU 30 calculates the evaluation value EVa, and then determines whether the evaluation value EVa is less than 0 (FIG. 7: S500). If the evaluation value EVa is less than 0, the CPU 30 determines that the pixel of interest represents a halftone part (S510). If the evaluation value EVa is 0 or greater than 0, the CPU 30 determines that the pixel of interest represents an edge part (S520). The CPU 30 then terminates the attribute determination process, and returns the process to the area classification process depicted in FIG. 3.

In Embodiment 1, attributes are determined using respective variances of a plurality of partial areas of different size, as described above. Specifically, attributes are determined in consideration of both the local and global viewpoints. As a result, accuracy of determination can be improved. Additionally, since variance is calculated using integrated data, excessive numbers of accesses to memory can be avoided, even where variances are calculated in relation to multiple pixel locations of the target image data SI. The processing load associated with mathematical operations can be reduced as well.

In this embodiment, tone values of luminance are calculated from RGB tone values, and attribute determination is carried out using the luminance tone values, since color change is easily detected. However, tone value used in the attribute determination is not limited to that representing luminance, and tone value representing any color component may be employed as well. For example, where the image data is provided in the YCbCr format, the Y component of the image data may be used directly as the luminance tone value; or the Cb component or the Cr component may be used. Where pixel tone values are provided in the RGB format, the R component etc. may be used.

According to the printer 10 having the configuration described above, variances are calculated for pixel groups of predetermined ranges around a pixel of interest, evaluation value EVa is calculated based on the variances, and the attribute of the pixel of interest is determined based on the calculation result. Accordingly, determination of pixel attribute (in this embodiment, an edge constituent part or a halftone constituent part) can be carried out by simple mathematical operations (mainly calculation of variance). Since the determination technique relies on simple mathematical operations, it may be provided inexpensively as software. Moreover, the determination technique is configured with a combination of simple mathematical operations, the technique can be implemented as parallel processing adapted to SIMD (Single Instruction Multiple Data), making high speed processing possible. For example, reading of image data and area classification (determination) could be parallelized.

### B. Embodiment 2

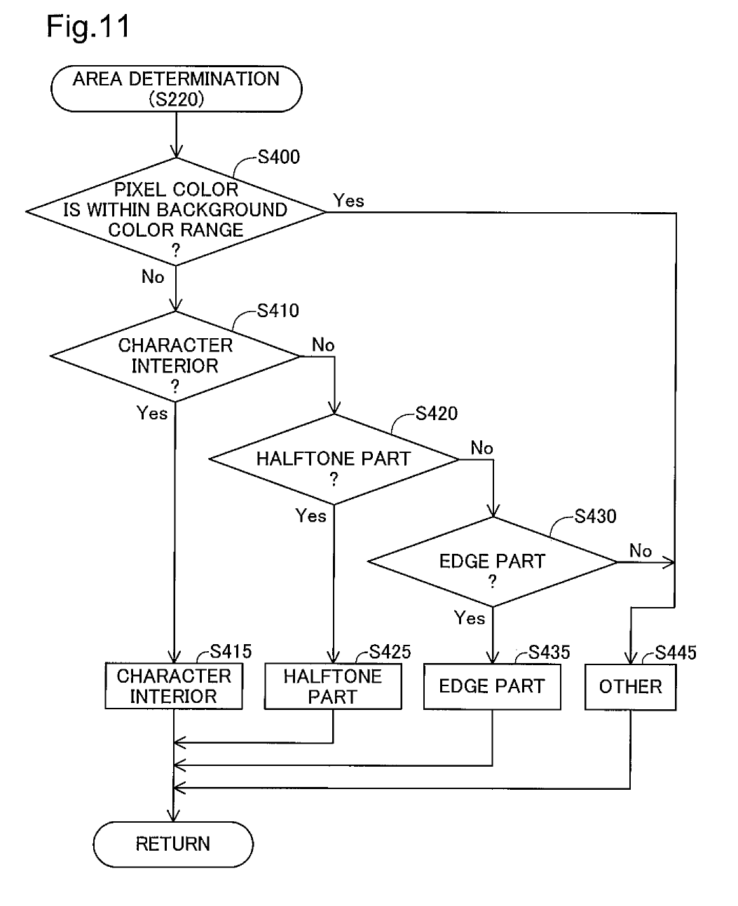

FIG. 11 is a flowchart depicting another embodiment of the area determination process (attribute determination process) shown in Step S220 of FIG. 3. The difference from the embodiment depicted in FIG. 7 is that here four types of determination may be made: “character interior” and “other” in addition to “halftone part” and “edge part.” The CPU 30 (FIG. 1) performs the processes of Steps S440 to S445 as processes of the area determination module 334 included in the area classification module 33. Note that the character includes various graphic symbols including not only alphanumeric characters but letters, signs, marks and symbols.

In the initial Step S400, the CPU 30 will determine whether the color of the pixel of interest is included in the background color range. If the color of the pixel of interest is included in the background color range, the CPU 30 determines that the pixel of interest represents “other” (Step S445). The background color range refers to the range of color representing background portions in the target image. As the background color range, the CPU 30 may employ, for example, a color range of predetermined size centered on average color of a predetermined border area in the target image. As the border area, for example, a partial area within 20 pixels from the border of the target image may be employed. Where the target image represents a printout using white paper, a color range representing the white color of the paper would be used as the background color range. Instead, a predetermined color range (e.g. a color range with a luminance value equal to or greater than a predetermined threshold value) could be used.

In the next Steps S410, S420, S430, the CPU 30, using the luminance value variance, determines whether the pixel of interest belongs to an character interior, a halftone part, or an edge part.

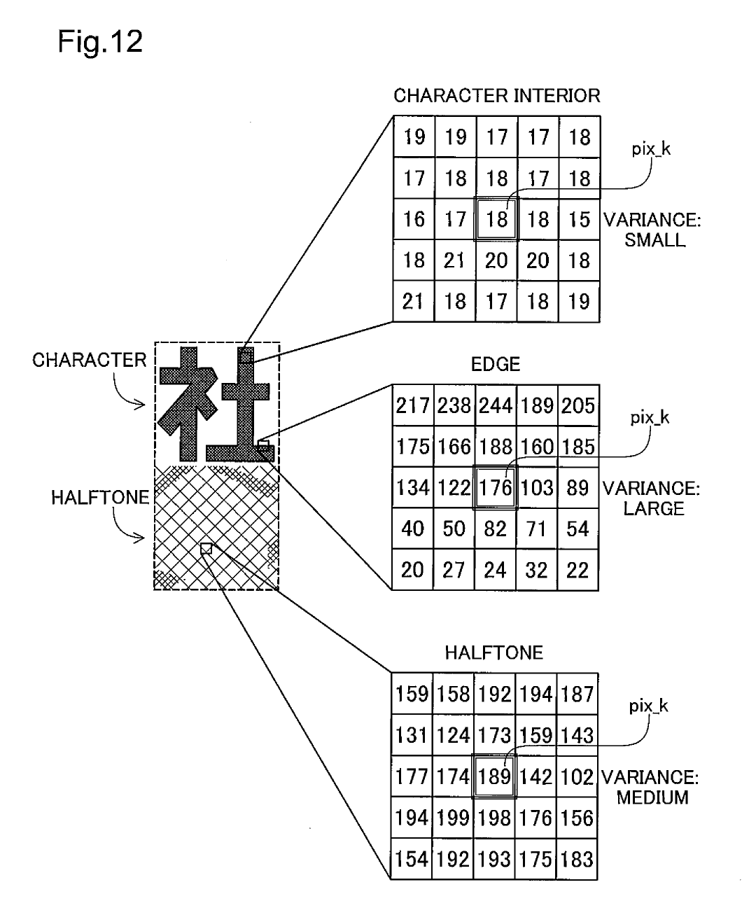

FIG. 12 depicts an example of luminance values in three partial areas. The only difference from FIG. 8 is the additional character interior. If the pixel of interest pix_k represents an character interior, all pixels within the partial area associated with the pixel of interest pix_k will have almost the same color. Therefore, the luminance value variance is typically small in comparison with halftone parts.

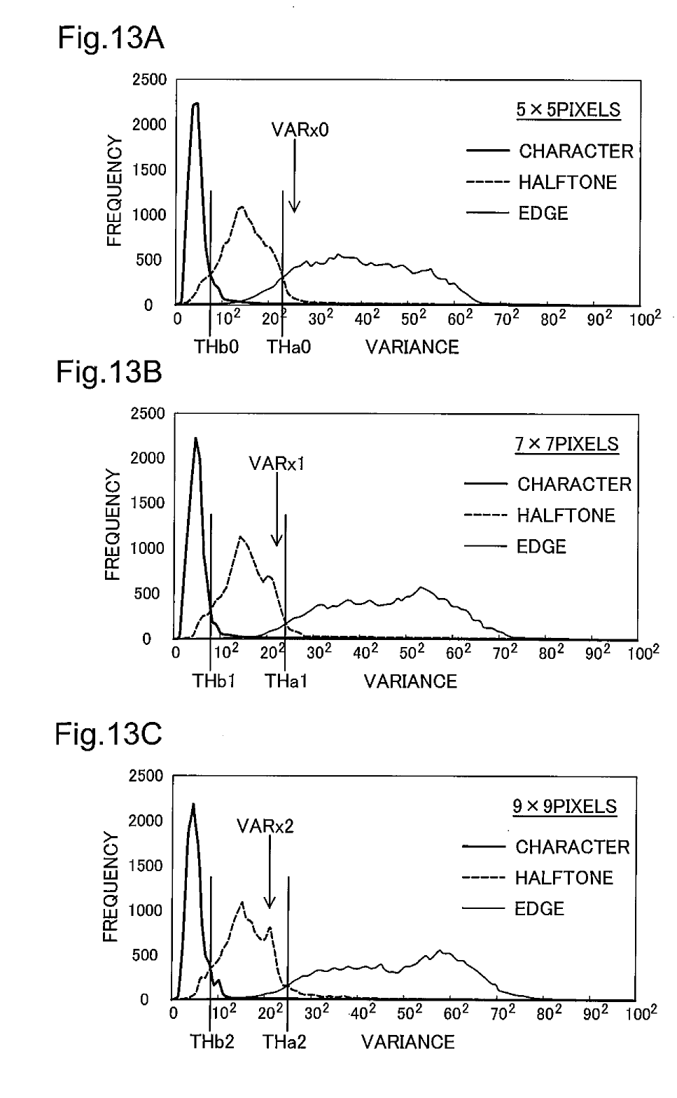

FIGS. 13A, 13B, and 13C depict exemplary histograms of variance in the three respective partial areas. The only difference from FIGS. 9A-9C is the additional histogram for character interior. As illustrated, the bias in the variance distribution will differ between the character interior and the halftone part. Accordingly, in a manner analogous to determination of halftone parts and edge parts, it can be possible to determine whether a pixel of interest represents a character interior or a halftone part with a certain level of accuracy by comparing the magnitude of variance with threshold values THb0, THb1, THb2.

In Step S410 of FIG. 11, using a method similar to the embodiment in FIG. 7, the CPU 30 (FIG. 1) determines whether the pixel of interest represents a “character interior.” Step S420 is the same as Step S500 of FIG. 7 (determination of whether the pixel of interest represents a “halftone part”). In Step S430, the CPU 30 determines whether the pixel of interest represents an “edge part” using a method similar to the embodiment in FIG. 7. In the event that variance is excessively large, the CPU 30 determines that the pixel of interest does not represent an edge part (Step S430). However, Step S430 may be omitted. In this case, all pixels not determined to belong to background, to character interior, or to halftone parts will be designated as belonging to edge parts.

The respective determinations in Steps S410 and S430 are made utilizing an evaluation value similar to the evaluation value EVa given above (Eq. 6). In Step S410, if the evaluation value is less than 0, the CPU 30 determines that the pixel of interest represents a character interior. If the evaluation value is 0 or above, the CPU 30 determines that the pixel of interest does not represent a character interior. In Step S430, if the evaluation value is less than 0, the CPU 30 determines that the pixel of interest represents an edge part. If the evaluation value is 0 or above, the CPU 30 determines that the pixel of interest does not represent an edge part. The coefficient (corresponding to the coefficient Cat) and threshold value (corresponding to the threshold value THat) used in computing each evaluation value in Step 410 and Step S430 may be determined experimentally and empirically in advance through analysis of a large number of images.

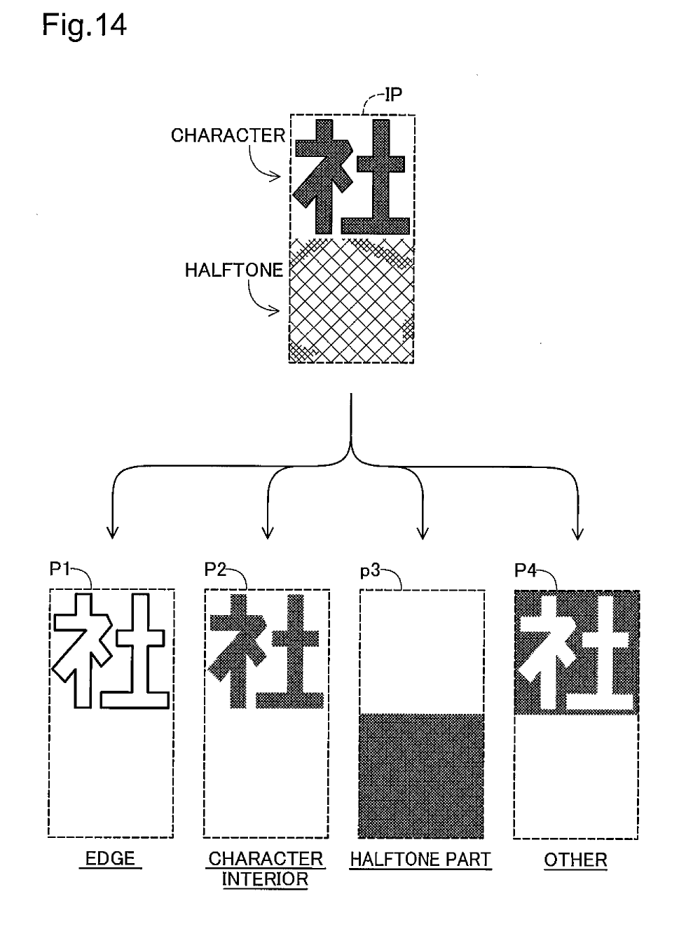

FIG. 14 is a schematic illustration depicting results of determination of image areas IP representing an character and halftones. The first pattern P1 is a binary pattern representing pixels belonging to edge parts. The second pattern P2 is a binary pattern representing pixels belonging to character interiors. The third pattern P3 is a binary pattern representing pixels belonging to halftone parts. The fourth pattern P4 is a binary pattern representing pixels belonging to “other.” In the drawing, pixels belonging to the respective parts are represented by solid lines or by hatching. As illustrated, pixels representing the contours of the character will be determined to represent edge parts; pixels representing the interior of the character will be determined to represent character interiors; pixels representing halftone images will be determined to represent halftone parts; and the background will be determined to represent “other.”

In Step S240 of FIG. 3, the CPU 30 (FIG. 1) stores (writes) the determination results into the RAM 40 as a process of the area determination module 334. As the data to be stored representing the determination results, for example, the data of the four binary patterns P1-P4 depicted in FIG. 14 may be employed, or quaternary pattern data indicating one of the four attributes for each pixel may be employed.

In Step S130 of FIG. 2, utilizing the determination results stored in the RAM 40, the CPU 30 identifies the attributes of the pixels and performs correction processes appropriate to the attribute of each pixel. For example, “character interior” pixels may undergo a smoothing process. By so doing, color deviation within the character can be reduced, making the character more visible. However, the correction process for “character interior” pixels may be omitted. Also, a smoothing process may be carried out for “other” pixels. Background noise can be reduced thereby. However, the correction process for other” pixels may be omitted.

### C. Modifications:

Of the elements taught in the embodiments described above, those elements not claimed in independent claims are optional elements and may be omitted. It is to be understood that the invention is not limited to the examples and embodiments described above, and may be embodied in various forms within its scope. It can be embodied according to the following modifications, for example.

### Modification 1:

In the embodiments described above, the total number of attributes for determination is not limited to two or four, and any plural number would be possible. For example, in the embodiment of FIG. 11, Steps S400, S430, and S445 may be eliminated. As pixel attributes, it would be possible to employ any of various attributes relating to types of image areas represented by pixels, such as character interior, edge parts, halftone parts, or photographic image areas for example.

### Modification 2:

In the embodiments described above, determinations may be made using a single partial area. However, accuracy can be improved by utilizing N partial areas (N is an integer equal to 2 or greater than 2). The N partial areas are not limited to the partial areas SAk0, SAk1, SAk2 depicted in FIG. 4, various rectangle areas differing in at least either one among size and shape from each other may be employed. For example, it would be acceptable to utilize three partial areas of 9×9 pixels, 11×11 pixels, and 13×13 pixels. Moreover, the partial areas are not limited to square shape; rectangular shapes of differing vertical and horizontal length are acceptable as well. For example, two partial areas of 5×7 pixels and 7×5 pixels could be used. In any case, the pixel of interest pix_k need not be the center pixel of the partial area. However, it is preferable to employ a rectangle area that includes the pixel of interest pix_k at a predetermined location in the rectangle area.

The value utilized for attribute determination is not limited to variance, and it would be possible to employ various other values correlated to variance of the tone values (such values correspond to the variation index). For example, standard deviation could be used. In this case as well, determination can be carried out at high speed if the CPU 30 calculates the average value E(f), E(f²) using integrated data, and then uses these average values E(f), E(f²) to calculate the standard deviation.

In the embodiments described above, the evaluation value utilized for attribute determination is not limited to the value given by Eq. 6, and it would be possible to employ any of various values calculated by summing M variation indices (e.g. variances) of M partial areas (M is an integer equal to 1 or greater than 1). For example, the weighted sum of M variation indices could be employed as the evaluation value. In any case, with reference to the results of comparing the evaluation value with a predetermined threshold value, it will be possible to determine whether a pixel of interest represents an attribute associated with that threshold value. By making such determinations in relation to multiple attributes, determination of multiple attributes can be done. Here, different evaluation value calculation methods may be employed for different attributes.

The method of attribute determination on the basis of M (M is an integer equal to 1 or greater than 1) variation indices is not limited to one of comparing a evaluation value with a threshold value as described above (the evaluation value is calculated from M variation indices). Various other methods may be employed. For example, a lookup table that indicates associations between M variation indices and an attribute may be employed. Such a table would be derived in advance experimentally and empirically through analysis of a large number of images.

### Modification 3:

In the embodiments described above, the first pixel values of the first integrated data ID1 are not limited to the integrated luminance value p (total luminance value) per se, and it would be possible to employ various other values associated with the integrated luminance value p. That is, various values convertible to the integrated luminance value p may be employed. For example, a value derived by dividing the integrated luminance value p by the total number of pixels of the rectangle area IAt (FIG. 5) (in other words, the average) could be employed. By so doing the memory size needed to store the first integrated data can be reduced appreciably. In this case as well, since the CPU 30 can easily specify the total number of pixels of the rectangle area IAt on the basis of the location of the pixel pix, the integrated luminance value p can be easily calculated from the pixel values (the average value) of the first integrated data. It is accordingly possible in this way to employ, as the pixel values of the first integrated data, values that permit calculation of the integrated luminance value p by a function of the pixel value and the pixel location (at least either one among row location and column location).

Moreover, the first calculation value that is calculated from the first integrated data ID1 is not limited to the average luminance value E(f), it being possible to employ various other values correlated with the sum of tone values in the target rectangle area Ad (FIG. 6). For example, the total luminance value within the target rectangle area Ad could be employed.

Additionally, the method by which the first calculation value is calculated from the first integrated data ID1 is not limited to one utilizing the integrated luminance values p of the four calculation pixels derived from the first integrated data ID1, and various other methods could be employed. For example, suppose here that the first integrated data ID1 represents the average luminance value. In this case, average luminance value within the target rectangle area Ad (FIG. 6) could be calculated through addition and subtraction using the respective average luminance values of the four calculation pixels pix_{—}1 to pix_{—}4 weighted according to the total number of pixels of the rectangle areas (FIGS. 5 and 6). For example, suppose that the average luminance value of 120 pixels is 30, and the average luminance value of 40 pixels from among these 120 pixels is 50. Here, the average luminance value of the remaining 80 pixels will be calculated by the following operation. Average luminance value=(30×(120/80)−50×(40/80)=30×1.5−50×0.5=45−25=20. The average luminance value within the target rectangle area Ad can be calculated by repeating such operation for the four calculation pixels. Further, the total luminance value within the target rectangle area Ad can be calculated by multiplying the total number of pixels of the target rectangle area Ad by the average luminance value so derived.

The above discussion in relation to the first integrated data ID1 applies analogously to the second integrated data ID2. In this case, sum of squared luminance values would be substituted for the integrated luminance value (sum of luminance values) in the above discussion, and the average squared luminance value (mean of squared luminance values) would be substituted for the average luminance value. The above discussions are applicable analogously to values other than luminance values, used as the tone values (e.g. the Cb component, Cr component, hue value, or chromaticity value).

### Modification 4

In the embodiments described above, the image processing carried out in accordance with those calculation results which utilized integrated data is not limited to attribute determination, and it would be possible to employ various other image processes in relation to a target rectangle area. For example, it would be possible to employ a process for adjusting brightness of a user-specified rectangle area. Here, in some instances luminance values of individual pixels within the rectangle area will be multiplied by a ratio of a predetermined reference value to average luminance value within the rectangle area. In this case, integrated data may be employed for computing the average luminance value. Here, in place of the average luminance value it would be possible to use any one selected from the total luminance value within the rectangle area, sum of squared luminance values within the rectangle area, and the average squared luminance value within the rectangle area. Any of these parameters can be calculated easily using integrated data as described above. It would also be possible to employ a process for adjusting contrast of a user-specified rectangle area. Here, in some instances, the magnitude of contrast adjustment will be set to a higher level in association with smaller variation index (e.g. variance) of luminance values within the rectangle area. In this case, integrated data may be employed in calculating the variation index.

### Modification 5:

In the embodiments described above, the process carried out for each classified area (attribute) is not limited to an image correction process (picture quality adjustment process), and it would be possible to employ various other processes. For example, data could be compressed at different compression ratios, for individual attributes.

Moreover, applications for the tone value data that has been image-processed in accordance with calculation results using integrated data are not limited to printing, and it would be possible to employ various other applications. For example, the tone value data could be used to display an image on a display device, or provided to the user as a data file containing image data. In this case, the display device may show the image after correction processes for each of the plural attributes. The user could also be provided with a data file containing tone value data that has undergone correction processes for each of the plural attributes. The user could also be provided with a data file containing image data with appended flags representing attributes of individual pixels.

### Modification 6:

While the invention has been shown hereinabove in terms of certain preferred embodiments, the invention is not limited to these particular embodiments and may be embodied in various other modes without departing from the spirit and scope of the invention. For example, the image processing device of the invention is not limited to a multifunction printer, and could be installed in various other digital devices such as a single-function printer, a digital copier, or an image scanner. No particular limitation to embodiment as an image processing device is imposed, and the invention may be embodied in various other modes such as a determination method of determining attributes in relation to types of image areas represented by pixels, a computer program for the same, and so on.

### Modification 7

In the preceding embodiments, some elements implemented with hardware could instead be implemented with software, and conversely some elements implemented with software could instead be implemented with hardware. For example, the functions of the characteristic quantity calculation module 332 of FIG. 1 could be implemented by hardware circuitry having a logic circuit.

Where part or all of the functions of the invention are implemented using software, the software (computer program) for this purpose can be provided in a form stored on a computer-readable recording medium. A “computer-readable recording medium” herein is not limited to a portable recording medium such as a flexible disk or a CD-ROM, but also includes various types of internal storage devices such as RAM and ROM, and various types of external storage devices fixed to a computer, such as a hard disk or the like.

### Other Modifications

Various aspects of the invention are previously discussed in this specification. Furthermore, it is possible to employ the following aspect.

Aspect 2. The image processing device according to the first aspect, wherein

the integrated data generator further generates second integrated data representing respective second pixel values of the pixels, the second pixel value being associated with sum of squared tone values of pixels within a rectangle in the image, the rectangle having two opposing corners represented by a pixel corresponding to the second pixel value and the reference pixel respectively, and

the calculation process includes calculation of a second calculation value using respective second pixel values of the four calculation pixels, the second calculation value being correlated to sum of squared tone values within the target rectangle area.

With this arrangement, the respective second pixel values of four calculation pixels in the second integrated data are utilized to calculate a second calculation value having correlation with the sum of squared tone values within the target rectangle area, thereby reducing the processing load associated with processing of tone value data.

Aspect 3. The image processing device according to aspect 2, wherein

the calculation process further includes calculation of a variation index using the first calculation value and the second calculation value, the variation index being correlated to variance of the tone values within the target rectangle area.

With this arrangement, that processing load can be reduced which is associated with calculation of the variation index having correlation with the variance of tone values within the target rectangle area.

Aspect 4. The image processing device according to aspect 3, wherein

the image processor determines an attribute relating to type of image area represented by a target pixel according to the variation index, the target pixel being a pixel at a predetermined location within the target rectangle area.

With this arrangement, that processing load can be reduced which is associated with determination of attribute relating to type of image areas represented by the target pixel.

Aspect 5. The image processing device according to aspect 4, wherein

the calculation of the variation index includes calculation of N (N is an integer equal to or greater than 2) variation indices associated with N target rectangle areas respectively, the N target rectangle areas being associated with a common target pixel, the N target rectangle areas differing in at least either one among size and shape from each other; and

the image processor determines the attribute in accordance with the N variation indices.

With this arrangement, since attribute is determined in accordance with N variation indices, the accuracy of determination can be improved and processing load can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing device for processing an image including a plurality of pixels, comprising:
an integrated data generator that generates first integrated data using tone value data, the tone value data representing respective tone values of pixels of an image, the first integrated data representing respective first pixel values of the pixels, the first pixel value being associated with sum of tone values of pixels within a rectangle in the image, the rectangle having two opposing corners represented by a pixel corresponding to the first pixel value and a reference pixel respectively, the reference pixel being a pixel at a predetermined corner of the image;
a calculator that executes a calculation process including calculation of a first calculation value of a target rectangle area using the first integrated data, the first calculation value being correlated to sum of tone values within the target rectangle area, the target rectangle area being enclosed by a rectangle defined by pixel boundary lines, the pixel boundary lines representing boundary lines between neighboring pixels in the image; and
an image processor that executes image processing in relation to the target rectangle area, in accordance with the result of the calculation process, wherein
in the calculation of the first calculation value, the first calculation value is calculated using respective first pixel values of four calculation pixels, the four calculation pixels being respectively adjacent to four vertexes of the target rectangle area in the direction of the reference pixel, the four vertexes being on the pixel boundary lines.

2. The image processing device according to claim 1, wherein
the integrated data generator further generates second integrated data representing respective second pixel values of the pixels, the second pixel value being associated with sum of squared tone values of pixels within a rectangle in the image, the rectangle having two opposing corners represented by a pixel corresponding to the second pixel value and the reference pixel respectively, and
the calculation process includes calculation of a second calculation value using respective second pixel values of the four calculation pixels, the second calculation value being correlated to sum of squared tone values within the target rectangle area.

3. The image processing device according to claim 2, wherein
the calculation process further includes calculation of a variation index using the first calculation value and the second calculation value, the variation index being correlated to variance of the tone values within the target rectangle area.

4. The image processing device according to claim 3, wherein
the image processor determines an attribute relating to type of image area represented by a target pixel according to the variation index, the target pixel being a pixel at a predetermined location within the target rectangle area.

5. The image processing device according to claim 4, wherein
the calculation of the variation index includes calculation of N (N is an integer equal to or greater than 2) variation indices associated with N target rectangle areas respectively, the N target rectangle areas being associated with a common target pixel, the N target rectangle areas differing in at least either one among size and shape from each other; and
the image processor determines the attribute in accordance with the N variation indices

6. An image processing method of processing an image including a plurality of pixels, comprising:
generating first integrated data using tone value data, the tone value data representing respective tone values of pixels of an image, the first integrated data representing respective first pixel values of the pixels, the first pixel value being associated with sum of tone values of pixels within a rectangle in the image, the rectangle having two opposing corners represented by a pixel corresponding to the first pixel value and a reference pixel respectively, the reference pixel being a pixel at a predetermined corner of the image;
executing a calculation process including calculation of a first calculation value of a target rectangle area using the first integrated data, the first calculation value being correlated to sum of tone values within the target rectangle area, the target rectangle area being enclosed by a rectangle defined by pixel boundary lines, the pixel boundary lines representing boundary lines between neighboring pixels in the image; and
executing image processing in relation to the target rectangle area, in accordance with the result of the calculation process, wherein
in the calculation of the first calculation value, the first calculation value is calculated using respective first pixel values of four calculation pixels, the four calculation pixels being respectively adjacent to four vertexes of the target rectangle area in the direction of the reference pixel, the four vertexes being on the pixel boundary lines.

7. A computer program product for processing an image including a plurality of pixels, comprising:
a computer-readable medium; and
a computer program stored on the computer-readable medium including:
a first program for causing a computer to generate first integrated data using tone value data, the tone value data representing respective tone values of pixels of an image, the first integrated data representing respective first pixel values of the pixels, the first pixel value being associated with sum of tone values of pixels within a rectangle in the image, the rectangle having two opposing corners represented by a pixel corresponding to the first pixel value and a reference pixel respectively, the reference pixel being a pixel at a predetermined corner of the image;
a second program for causing the computer to execute a calculation process including calculation of a first calculation value of a target rectangle area using the first integrated data, the first calculation value being correlated to sum of tone values within the target rectangle area, the target rectangle area being enclosed by a rectangle defined by pixel boundary lines, the pixel boundary lines representing boundary lines between neighboring pixels in the image; and
a third program for causing the computer to execute image processing in relation to the target rectangle area, in accordance with the result of the calculation process, wherein
in the calculation of the first calculation value, the first calculation value is calculated using respective first pixel values of four calculation pixels, the four calculation pixels being respectively adjacent to four vertexes of the target rectangle area in the direction of the reference pixel, the four vertexes being on the pixel boundary lines.
